(19) United States
(12) Patent Application Publication
(10) Pub. No.: US 2023/0346188 A1
(43) Pub. Date: Nov. 2, 2023

(54) FLOOR-CLEANING APPLIANCE, IN PARTICULAR A FLOOR SCRUBBER, HAVING IMPROVED MANOEUVRING PROPERTIES

(71) Applicant: I-MOP GMBH, Bensheim (DE)

(72) Inventor: Rudolf FRANKE, Bensheim (DE)

(21) Appl. No.: 18/017,227

(22) PCT Filed: Jul. 22, 2021
(86) PCT No.: PCT/EP2021/070567

§ 371 Date: Jan. 20, 2023

(30) Foreign Application Priority Data
Jul. 22, 2020 (DE) 10 2020 004 413.1

(51) Int. Cl. A47L 11/30; F16C 11/04; A47L 11/40

(52) U.S. Cl. CPC A47L 11/4061; A47L 11/305; A47L 11/4038; F16C 11/04

(57) ABSTRACT

The invention relates to a floor cleaning device comprising a floor unit which is assigned a direction of advance parallel to a floor surface to be cleaned; a tool which, in an operating state, contacts the floor surface, the tool being movable relative to the floor surface by means of a drive; a guide member for guiding the floor cleaning device; and a joint assembly connecting the floor unit and the guide member in an articulate manner. When in a maneuvering operating state, the guide member can pivot about a first pivot axis and can be fixed or temporarily supported in the first pivot axis plane. As a result of the pivoting movement of the guide member about the first pivot axis, an advance effect brings about a moment of rotation of the floor unit on the floor surface that benefits the maneuvering of the floor cleaning device.

### CROSS REFERENCE TO RELATED PATENT APPLICATIONS

The present application is a U.S. national stage application under 35 U.S.C. § 371 of PCT Application No. PCT/EP2021/070567, filed Jul. 22, 2021, which claims priority to German Patent Application No. 102020004413.1, filed Jul. 22, 2020. The disclosures of the aforementioned priority applications are incorporated herein by reference in their entireties.

The present invention relates to a floor cleaning device, in particular a scrub vacuum floor cleaning device, such as a wet floor cleaning device, comprising:
a floor unit which is assigned a direction of advance (V) parallel to a floor surface to be cleaned,
a tool which is assigned to the floor unit and which, in an operating state, contacts the floor surface, the tool being movable relative to the floor surface by means of a drive;
a guide member for guiding the floor cleaning device; and
a joint assembly connecting the floor unit and the guide member in an articulate manner;
   wherein the floor cleaning device is preferably configured to produce an advance effect with respect to the floor surface in the direction of advance (V),
   wherein the joint assembly is configured with a first pivot joint having a first pivot range with a defined or virtual first pivot axis and allowing a pivot movement of the guide member relative to the floor unit about the first pivot range, in particular about the first pivot axis,
   wherein the first pivot axis is in a first pivot axis plane which is perpendicular to the floor surface and contains a direction vector defining the direction of advance.

Cleaning devices with structures of differing complexity are known from the prior art.

Document DE 10 2009 028 944 A1 is cited as the closest prior art for the present invention. It describes a floor cleaning device having the features of the preamble according to the present claim 1. Although the basic design of this device proved its worth in practice thanks to favorable maneuverability, further developments were necessary.

The German utility model specification DE 20 2013 012 528 U9 describes a floor cleaning device in which a beneficial arrangement of two cleaning tools in conjunction with one vacuum bar improves the cleaning and drive functions over DE 10 2009 028 944 A1.

Furthermore, document EP 2 832 277 B1, for example, shows a further development that is based on the subject matter of DE 10 2009 028 944 A1 and provides improved drive properties and a vacuum drive integrated in the guide member.

Document DE 10 2016 208 895 A1 describes a floor cleaning device with a space-saving arrangement of drive components in the floor unit.

The granted European patent EP 3 031 378 B1 describes a floor cleaning device providing means for switching the device between an operating position and a space-saving transport or storage position as required.

As further prior art, reference is made to US 2013/0133146 A1, US 2012/0246848 A1 and US 2,818,312, all of which specify projecting fork arrangements that can be pivoted about an axis extending transversely to the direction of advance.

It has been shown that all these devices are difficult for an operator to maneuver, at least in certain operating situations, despite selective further developments and increasing integration of the individual components. To a large extent, these devices have the disadvantage that, due to the installation of energy supply elements, fresh water and waste water tanks as well as various operating, control and drive components on the guide member, the guide member itself becomes larger and heavier in some cases, which makes the floor unit more compact, but also makes handling difficult for an operator, especially during longer operation. Even if the aforementioned further developments in the floor unit have improved the maneuvering properties to some extent with regard to the prior art, depending on the operating situation, the prior art still requires an operator to bear a greater or lesser proportion of the weight of the guide member during operation. In the long run, this can lead to operator fatigue. In addition, maneuverability of the floor cleaning device is impaired as a result.

Hence, it is an object of the present invention to provide a floor cleaning device of the type described at the outset, which makes extensive use of the advantages known from the prior art while taking into account the need to improve the maneuvering properties.

This object is achieved with a floor cleaning device of the type described at the outset, in which in a maneuvering operating state, the guide member can be pivoted about the first pivot axis relative to the floor unit, wherein the guide member can be fixed or temporarily supported in the first pivot axis plane relative to the floor unit or to the floor, wherein, as a result of the pivoting movement of the guide member about the first pivot axis, with the support of the guide member in the pivot axis plane being conveyed, the advance effect or/and a maneuvering movement by an operator brings about a moment of rotation of the floor unit on the floor surface that benefits the maneuvering of the floor cleaning device and preferably acts about an axis of rotation that is substantially perpendicular to the floor surface. Such maneuvering movement can be, for example, an operator’s slight decentralized counteraction on the guide member against the advance effect which, together with the advance effect on the floor unit, leads to the rotational moment of the floor unit on the floor surface.

When in connection with the first pivot range it is mentioned that it has a defined or virtual first pivot axis, this means in the context of this document that the pivot range can be configured as a kind of joint with a permanent pivot axis or designed in such a way that the pivot axis changes over time during a pivot movement, for example when pivoting about a spring element that is flexible over a larger range, such as an elastic body or a helical or leaf spring or the like, or by means of an arc guide. However, it is important that pivoting is guided around the first pivot range and that the defined pivot axis and/or the virtual pivot axis, i.e. the pivot axis that is currently effective in the respective phase of pivoting but changes over the degree of pivoting around the pivot range, is/are in the first pivot axis plane.

The floor cleaning device according to the invention is characterized by the fact that in a maneuvering operating state the guide member is fixed or temporarily supportable or permanently supportable relative to the floor unit in a manner explained in detail below, namely completely or at least partially, so that the weight force of the guide member acts on the floor member and finally on the floor to be cleaned via the support. It is therefore no longer necessary for an operator to take over the weight force of the guide member in the same way as is the case with the prior art when the guide member of the operating device according to the invention is inclined backwards (i.e. towards the operator) in the maneuvering operating state and is thus supported, or when the latter is already positioned with its handle portion backwards due to the structure of the machine. An improvement is already achieved when the proportion of the weight force normally to be taken over by the operator can be reduced through the support. It is already an advantage when there is only partial support of the weight force. Depending on where the proportion of the weight force taken over via the support engages with the floor unit, the complete or at least partial introduction of the weight force of the guide member into the floor unit in the maneuvering operating state via the support offers additional advantages with regard to the maneuvering properties of the floor cleaning device according to the invention. The inclination of the guide member with respect to the direction of advance relates, for example, to a longitudinal guide member axis which is substantially orthogonal to the first pivot axis in the longitudinal direction of the guide member and extends through a line of action which is determined by points of engagement for an operator on the guide member for maneuvering the floor cleaning device, for example using handles.

In any case, the at least partial support of the weight force of the guide member on the floor unit has the effect of a decentralized, i.e. sideways, weight distribution when the guide member is pivoted relative to the floor unit about the first pivot axis of the joint assembly in the floor unit or/and the operator performs a maneuvering movement on the guide member. This in itself already results in a rotational moment in the floor unit, preferably about an axis of rotation that is perpendicular to the floor surface. This rotational moment, which has a positive impact on the maneuvering properties of the floor cleaning device according to the invention, is reinforced by the fact that an advance effect can be generated in the floor unit, preferably via the at least one rotating tool or by means of other components, which additionally supports a steering movement due to the decentralized weight distribution. Due to the pivoted guide member, the force acting along the guide member is transmitted to the floor unit with a vertical force component and a horizontal force component. While the vertical force component can be introduced fully or partially into the floor unit via the joint assembly and the support, the horizontal force component acts as a transverse force in the floor unit. This makes the advance effect more noticeable in certain areas of the floor unit, particularly in connection with the operator’s counteracting maneuvering movement, which has a positive effect on the maneuvering properties, as explained in detail below. Thus, the invention utilizes the weight force of the guide member introduced into the floor unit due to the pivoted guide member having a transverse component together with the maneuvering movement conveying the advance effect to improve the maneuvering properties of the entire floor cleaning device. However, the advantages of the invention also come into play, albeit to a lesser extent, when the at least one rotating tool does not produce an advance effect.

According to an embodiment of the floor cleaning device according to the invention, it may be provided that in the maneuvering operating state, the first pivot axis and the direction vector defining the direction of advance enclose an acute angle ranging between 5° and 85°, preferably between 15° and 45°. This means that the first pivot axis is oriented in such a way that the guide member is inclined backwards towards the operator in a cleaning operating state and/or maneuvering operating state of the floor cleaning device. This makes it possible for the weight force of the guide member to result in a tilting moment in the floor unit transverse to the first pivot axis via the fixation and/or support of the pivot joint, and for the tilting moment to be at least partially counteracted by a counter moment. This is particularly the case if the handle portion is located in a vertical projection on the floor surface behind the floor unit.

An embodiment of the invention provides that the first pivot joint is permanently fixed to the floor unit about the first pivot axis or lockable in predetermined positions determining the alignment of the first longitudinal axis with the direction vector defining the direction of advance in the maneuvering operating state. In other words, the first pivot joint can be locked around the first pivot axis in a certain orientation permanently or in predetermined positions. The support of the weight force of the guide member into the floor unit can then be achieved through permanent or temporary locking. Furthermore, this results in the beneficial maneuvering properties described above.

As an alternative to permanent or predetermined locking, an embodiment of the invention provides that the joint assembly is configured with a second pivot joint having a second pivot range with a defined or virtual second pivot axis and allowing a pivot movement of the guide member relative to the floor unit about the second pivot range. The second pivot axis is substantially parallel to the floor surface and transverse to the first pivot axis. Floor cleaning devices having two pivot joints with pivot axes extending transversely, in particular orthogonally, to one another are already known from the prior art. For example, document DE 10 2009 028 944 A1 shows such a joint assembly with a double pivot joint. While such a joint assembly improves the maneuvering properties over earlier prior art, it has the disadvantage that in the maneuvering operating state a rather significant proportion of the guide member’s weight must be borne by the operator, as explained above. The present invention provides that via the support the joint assembly can permanently or temporarily, as required, be brought into a state in which this disadvantage is overcome. The support of the joint assembly can be provided directly on or in the joint assembly. Alternatively, the support of the joint assembly can be provided by attaching the support device to the guide member, in which case the support device is supported on the floor unit or directly on the floor. According to another alternative, the support of the joint assembly can be provided by attaching the support device to the floor unit, in which case the support device supports the guide member.

In this context, a beneficial embodiment of the invention provides that a support device is functionally assigned to a support device which, in the maneuvering operating state, supports the joint assembly with the first pivot joint relative to the floor unit at least temporarily or/and at least partially in the maneuvering operating state. Such a support device can, for example, be manually attached, electrically or electromagnetically connected or permanently available, optionally also with a linear or progressive or degressive support characteristic. As already explained above, the support of the joint assembly can be provided directly on the joint assembly or indirectly by attaching the support device to the guide member or to the floor unit.

In this context, a simple mechanical embodiment provides that the support device is lockable at least temporarily in at least one locking position, preferably in at least two, particularly preferably in at least three locking positions. Alternatively, it may be provided that the support device is continuously lockable.

In an embodiment of the invention, the support device may be rigid. This can be achieved, for example, with a support strut, a support bracket, a supporting receiving fork or a locking bracket.

As an alternative to an exclusively rigid support device, it can be provided in accordance with the invention that the support device comprises a spring element having a linear, stepped, degressive (decreasing) or progressive (increasing) support effect, depending on the angle between the first pivot axis and the direction vector defining the direction of advance. A combination of a progressive and degressive course of the supporting force acting during the support may also be provided, for example in such a way that the spring element is arranged such that the support device first provides a progressive support effect over a certain angular range and then a degressive support effect or vice versa.

To avoid undesirable vibration effects, in particular when using resilient support devices, or to avoid that a support state is reached abruptly, an embodiment of the invention may provide that a damper element is assigned to the support device. This measure, for example, helps to achieve a smooth damped transition between an unsupported and a partially or fully supported state.

According to an embodiment of the invention, the guide member is supported not only in the first pivot axis plane, rather a further support device is additionally assigned to the first pivot axis, which is configured to support the guide member at least partially also when pivoting about the first pivot axis out of the first pivot axis plane relative to the floor unit from a predetermined or predeterminable pivot angle. In other words, the guide member can also be supported when pivoting sideways at least from a certain pivot angle. The support can be provided as described above, for example be rigid, resilient and/or damped. Reference is made to the above explanations on support with respect to the first pivot axis, which herein also apply analogously to support with respect to a movement about the second pivot axis.

According to an embodiment of the invention, the support device is configured to guide the guide member when pivoting about the first pivot axis with respect to the floor unit, preferably along an arcuate path. For this purpose, the support device can be provided with a guide track in which a guide sled is guided onto which the guide member is placed or to which the guide member is coupled via a positive or non-positive connection. The coupling can be supported, for example, by a magnet arrangement of the approaching parts. In this context, it may further be provided that the support device is configured to resiliently support the guide member when pivoting about the first pivot axis, preferably progressively resiliently with increasing pivot angle. Thus, it is possible to provide a kind of restoring torque or restoring force that increases with increasing deflection of the guide member from a substantially central neutral position. This relieves or supports the operator during a maneuvering movement in which they move the guide member back to the neutral position after it has pivoted out.

According to the invention, it may further be provided that the joint assembly comprises a connecting member connecting the first pivot joint to the second pivot joint, wherein the connecting member is pivotable relative to the floor unit about the second pivot axis and the guide member is pivotable relative to the connecting member about the first pivot axis. This helps to achieve a kind of double universal joint assembly.

In this context, it is advantageously provided that the connecting member can be supported with respect to the base unit. The support device for support in the first pivot axis plane is thus coupled to the connecting member in order to maintain good mobility of the guide member about the first pivot axis - even in the case of effective support.

In this context, it is in particular provided that the respective support device is assigned to the connecting member and comprises a support member which in the maneuvering operating state, contacts the floor unit, thereby providing support.

In a preferred embodiment of the present invention, the respective support device may be formed integrally with the joint assembly. In this case, it is possible, as already indicated above, that the joint assembly is configured as a double universal joint and the support device or at least one of the support devices assigned to the two pivot axes is integrally formed with the double universal joint. Alternatively, it is possible to configure the support device as a separate assembly, for example in the form of a support module which can be attached to or removed from the floor cleaning device as required. For this purpose, a coupling interface may be provided which provides a secure yet detachable connection between the support module and the floor cleaning device.

Furthermore, according to the present invention, as already indicated above, the respective support device can be configured to be activated or deactivated by an operator as required. This can be done by mechanical displacement, for example by folding a support bracket back and forth, or by electromagnetic switching or activation of the respective support device or the like.

According to an embodiment of the invention, the support device is pivotable by an operator between an operating position and a parking position, wherein the support device is preferably lockable in at least one of the operating position and the parking position. This allows the support device to be used or removed as required, ideally remaining in both positions. This can be done, for example, by spring pre-load or a latching or locking device.

According to an embodiment of the invention, an adhesion member, in particular a magnet, is assigned to the support device and is configured to secure the support device during support against pivoting contrary to the support direction and/or transversely to the support direction until a force threshold value is exceeded. In other words, the support device can be held in a supporting operating position in a supporting manner to prevent an undesired stopping of the support effect.

An embodiment of the invention further provides that the support device provides, preferably via the adhesion member, a substantially positive or/and non-positive connection between the support device and the guide member and/or the floor unit. This helps to achieve secure coupling of the support device and guide member or floor unit during support, which prevents unintentional release. An at least partially positive connection can be provided, for example, by providing a simple recess or hollow with which the support device engages.

As regards the orientation of the pivot axes, it may be provided that the second pivot axis is substantially perpendicular relative to the first pivot axis. In this regard, it is further possible that the guide member comprises a longitudinal axis which is preferably perpendicular to the first pivot axis and, where applicable, perpendicular to the second pivot axis.

Mass distribution and support effect are beneficial when the joint assembly is attachable to the floor unit in such a way that the weight force of the guide member is introduced via the joint assembly into the floor unit at a geometric location of the floor unit which, as seen in the direction of advance, is located in front of a center of area or center of mass of the floor unit.

To change the mass distribution and thus to adjust the maneuvering properties of the floor cleaning device according to the invention as required, an embodiment of the invention provides that the floor unit comprises a fastening device by means of which the joint assembly can be variably fastened to the floor unit at different fastening positions along the direction of advance. This property can be achieved, for example, with the fastening device comprising a rail as well as a latching device, each of which can be fastened in the predetermined fastening positions.

However, the mass distribution can already be influenced by an operator pivoting the guide member around the second pivot axis. For example, in the support state, the entire floor cleaning device can be “tilted” backwards to a greater or lesser extent by pulling the guide member backwards against the support effect. This measure relieves the front area of the floor cleaning device, for example the cleaning tools or drive wheels producing the advance, by conveying the support effect, which can facilitate maneuvering. The aforementioned “tilting” can be in the range of a few angular minutes or a few angular degrees.

According to the invention, it may be provided that a mass ratio between the floor unit and the guide member ranges between 1:5 and 1:1 or between 1:1 and 5:1.

As already explained at the beginning, the floor cleaning device according to the invention provides at least optionally an advance effect at the floor unit. In this context, it can be provided that the at least one tool is configured to contact the floor surface in the operating state and to generate advance at least proportionately. However, the effect according to the invention is already achieved - at least to a limited extent - by the fact that the tools rotating in opposite directions to one another strongly reduce the friction between the floor cleaning device and the ground, even without advance effect. If the floor cleaning device is then pushed forward manually and the guide member is pivoted about the first pivot axis as described above, the forward movement and the associated inertia of the floor cleaning device from this forward movement alone can produce the favorable rotational moment of the floor unit described above.

In this context, according to the present invention, it is in particular possible that the tool of the floor unit comprises at least one rotationally driven brush having an axis of rotation that is oriented substantially parallel to the floor surface in the operating state.

An embodiment of the invention provides that a first brush comprises a first axis of rotation which, in the operating state, is slightly inclined relative to a perpendicular to the floor surface, and that a second brush comprises a second axis of rotation which, in the operating state, is equally slightly inclined relative to a perpendicular to the floor surface, the first and second brushes being configured to rotate in opposite directions. The directions of rotation can be freely selectable.

With regard to the inclination of the axes of rotation relative to the perpendicular, a specific embodiment of the floor cleaning device according to the invention may provide that the first axis of rotation and the second axis of rotation are inclined by 0.8° to 5°, preferably by about 1.5°, with respect to the perpendicular. The inclination can be adjustable by an operator through a suitable mechanism.

In addition or alternatively to a generation of the advance effect via the tools, the floor cleaning device according to the invention can further provide that the floor unit comprises at least one drive body, for example in the form of a wheel, a barrel or a roller-shaped cylinder which contacts the floor surface in the operating state and which is configured to generate advance at least temporarily and/or at least proportionately.

With regard to the advantages of the floor cleaning device according to the present invention when maneuvering, the following is added for better understanding:
The significantly improved maneuverability of the floor cleaning device according to the present invention compared to the prior art results from the support of the guide member explained at the outset in combination with the advance effect and any maneuvering movement of the operator, in particular in the case of the operator’s slight decentralized counteraction on the guide member.
If the guide member is pivoted about the first pivot range, in particular the first pivot axis, the floor cleaning device is moved out of a state of force balance.
The weight force to be taken over proportionately by the operator in the process is significantly lower than in conventional devices without support, which allow the guide member to be pivoted about an axis corresponding to the first pivot axis.
As a result, in the floor cleaning device according to the invention, the operator has to exert significantly less force during such a pivoting of the guide member to hold the guide member. The operator can hold and maneuver the guide member with ease.
A slight counteraction of the operator on the deflected guide member against the effect of the advance force ensures a corresponding rotational moment in the floor unit, which is supported by the advance effect. This effect is particularly noticeable if the operator slightly pulls the guide member back even against the advance effect.
The more the guide member is pivoted around the first pivot range in one direction or the other, the greater this effect is as a result of the counteraction or pulling back.
Even small pivot movements can be used to advantage during maneuvering by taking advantage of the support.
Maneuvering can be facilitated further when in addition to the above-mentioned counteraction or pulling back, the user presses the guide member slightly downwards towards the floor surface against the effect of the support. This increases the rotational moment in the floor unit by changing the force distribution in the floor unit on the one hand and by utilizing the advance effect on the other hand.

All these measures during maneuvering are relatively small interventions by the user, requiring only very little force.

Preferably, the floor cleaning device according to the invention further comprises a vacuum unit configured to suck up particles and/or liquid or generally dirty water from the floor surface. In this context, it is possible that the vacuum unit comprises at least one vacuum turbine arranged on or formed separately from the floor unit or the guide member and configured to generate a negative pressure. The vacuum effect may be assisted or enhanced by a linear or rounded vacuum bar arranged on the floor cleaning device’s rear side that faces the user. This vacuum bar may have one or more sealing lips. The vacuum bar and/or sealing lips can provide a frictional force relative to the floor surface, which can be an advantage in absorbing transverse forces introduced into the floor unit through the guide member. Transverse forces may also be absorbed by guide or drive wheels.

According to the invention, it is, however, equally possible to absorb dirty water in another way, for example through a fleece, a capillary absorption mechanism or a rotating roller or the like which absorbs the dirty water and conveys it into a collecting tank.

The floor cleaning device according to the invention may further comprise at least one holding tank configured to collect the particles sucked up and/or the liquid used for cleaning, wherein the holding tank is in particular arranged on the guide member or the floor unit such that it can be removed.

Furthermore, the floor cleaning device according to the invention may comprise a cleaning agent tank configured to provide a cleaning agent to the at least one tool preferably via a supply device, wherein the cleaning agent tank is arranged on the floor unit or on the guide member.

Furthermore, the floor cleaning device according to the invention may comprise a fresh water tank configured to provide fresh water to the at least one tool preferably via a supply device, wherein the fresh water tank is arranged on the floor unit or on the guide member.

The holding tank, the cleaning agent tank and the fresh water tank may be integrally formed in groups or as a whole.

According to a preferred embodiment of the floor cleaning device according to the invention, the floor cleaning device can be brought into a parking state, wherein in the parking state the floor unit is displaceable relative to the guide member into a space-saving parking position and lockable in such position.

According to an embodiment of the invention, the support device is configured to fully lock the guide member with respect to the floor unit, so that pivoting about the first pivot axis and, where applicable, about the second pivot axis is blocked at least in a predetermined angular range. According to this variant of the invention, it is possible to define the guide member relative to the floor unit in such a way that no relative movement or pivoting of the two components relative to each other is possible. In a further embodiment of the invention, such a complete locking or defining of the guide member and the floor unit relative to each other can be activated and deactivated as required. This can be achieved, for example, by the fact that the support device, as described in detail above, can be pivoted about a pivot axis into an active position and into a passive position, wherein in the active position, the support device provides for the complete locking of the guide member relative to the floor unit. In this case, the support device can support the guide member on the floor member, independently of the joint assembly. However, the support may also be integrated in the joint assembly or arranged in the immediate vicinity of the joint assembly. Such support is particularly suitable where the joint assembly is configured as a double universal joint or any other double joint. Preferably, the guide member becomes completely blocked relative to the floor unit when the guide member is somewhat inclined relative to the vertical axis, for example by 15-45°. The guide member may thus become completely blocked in a certain angular position so that it cannot be deflected or pivoted further relative to the vertical axis, but remains movable when pivoted back in the direction of the vertical axis.

The invention further relates to a support device of the type described above. It comprises a base attachable either to the shaft or to the floor unit. The attachment can be made in fixed predetermined positions or be variable. The support device further comprises at least one support strut which introduces the weight force of the shaft into the floor unit permanently or by displacement into a support position. The support strut can be folded back and forth between a support position and a parking position, for example. A locking mechanism or a magnet can be provided for fixing. As described above, the support device helps to support the weight of the guide member on the floor unit in a maneuvering operating state while the guide member remains maneuverable, i.e. pivotable about the first pivot axis. Furthermore, the support device may comprise a locking bracket which can be used to block pivoting of the guide member about the first pivot axis. The locking bracket may be configured to block any pivoting of the guide member about the first pivot axis or to block pivoting only from a predetermined pivot angle.

Finally, it is to be noted that the support device may also be provided as a retrofit kit, i.e. as a separate assembly which, if required, can be attached to a corresponding floor cleaning device to achieve the advantages described above, and removed from it.

In the following, embodiments of the invention are described by way of example with reference to the figures. In the drawings:

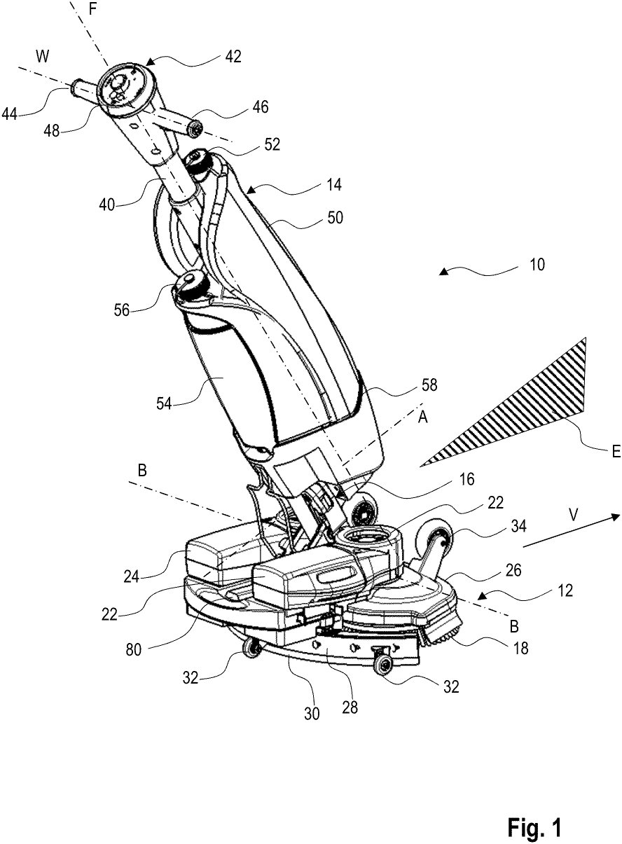

FIG. 1 is a spatial representation of a first embodiment of the floor cleaning device according to the invention with an activated bracket-like support device;

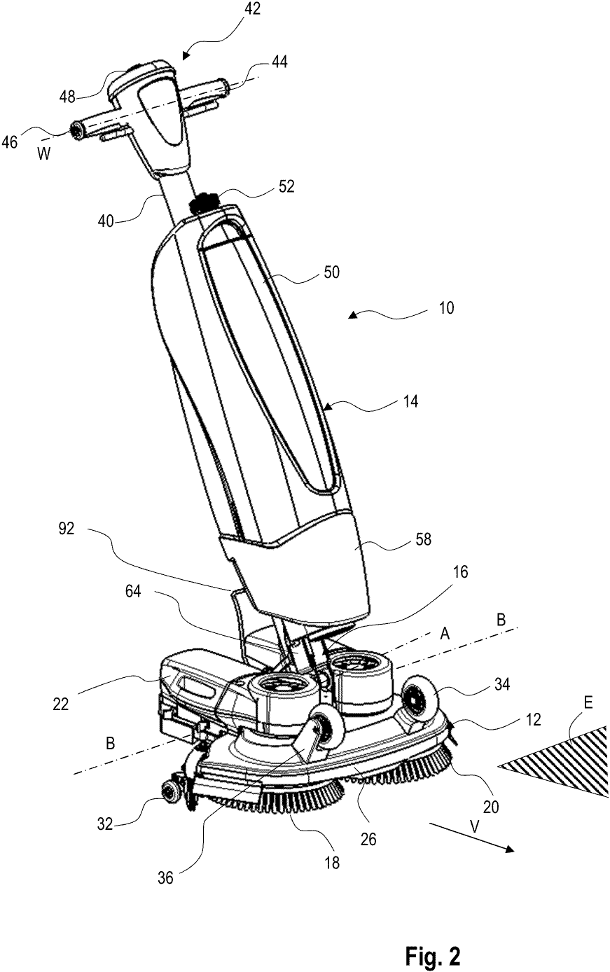

FIG. 2 is a spatial representation of the first embodiment of the floor cleaning device according to the invention from another perspective;

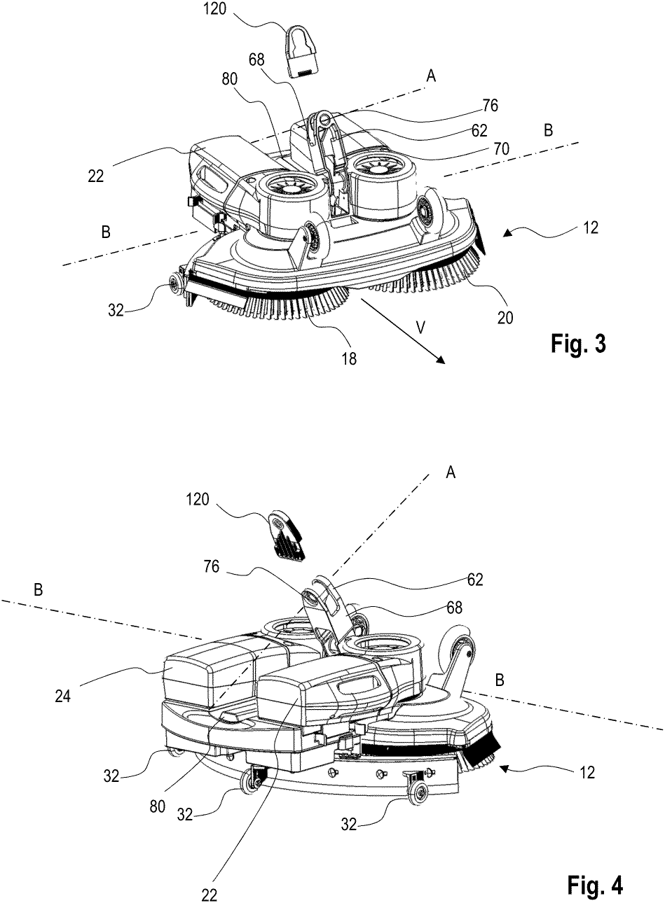

FIG. 3 is a detailed spatial representation of the floor unit and a part of the joint assembly of the first embodiment of the floor cleaning device according to the invention;

FIG. 4 is a detailed spatial representation of the floor unit and a part of the joint assembly of the first embodiment of the floor cleaning device according to the invention of FIG. 3 from another perspective;

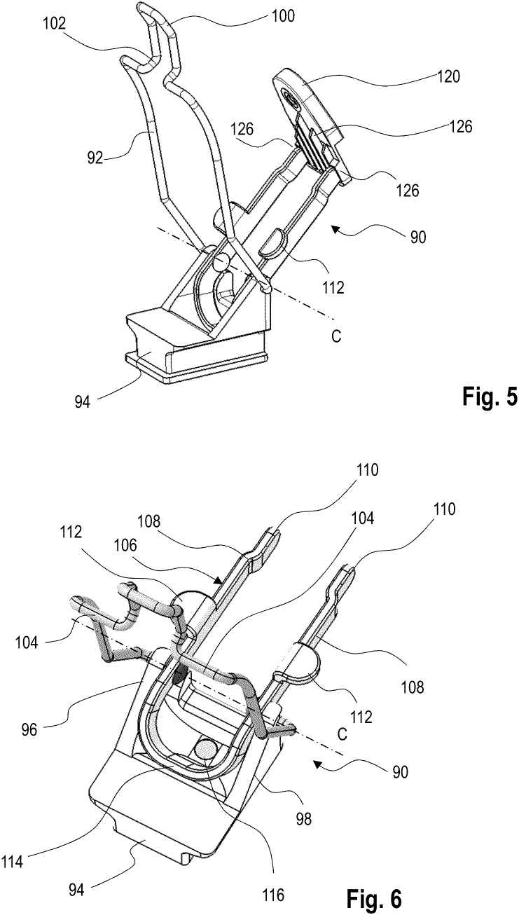

FIG. 5 is a detailed spatial representation of the support device of the first embodiment of the floor cleaning device according to the invention;

FIG. 6 is a detailed spatial representation of the support device of FIG. 5 from another perspective;

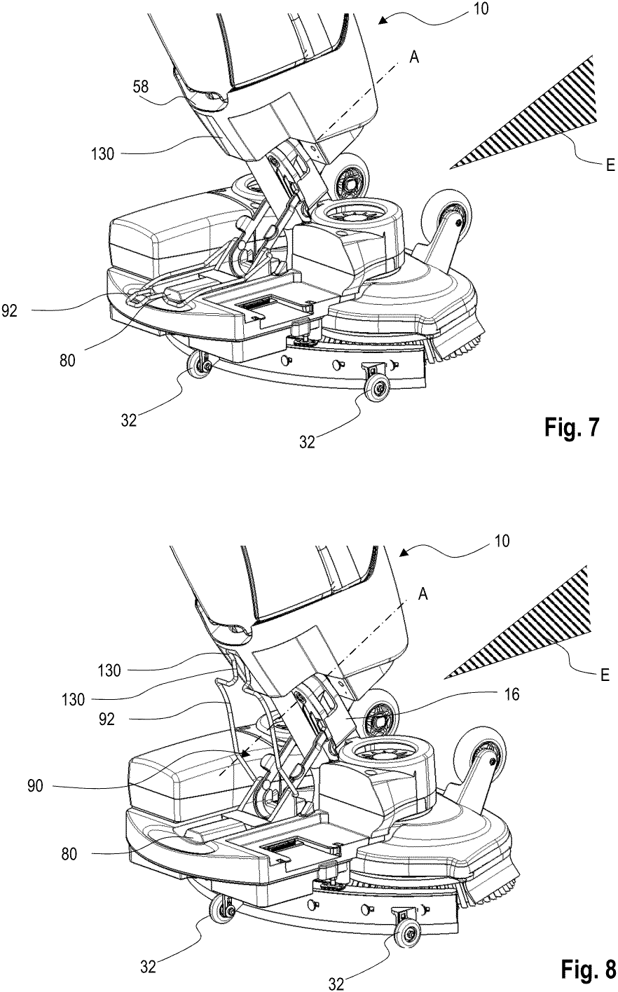

FIG. 7 is a detailed spatial representation of the floor unit and a part of the guide member of the first embodiment of the floor cleaning device according to the invention including the support device;

FIG. 8 is a detailed spatial representation of the floor unit and a part of the guide member of FIG. 7, but with the support device shown in a state that blocks lateral pivoting of the guide member about the first pivot axis;

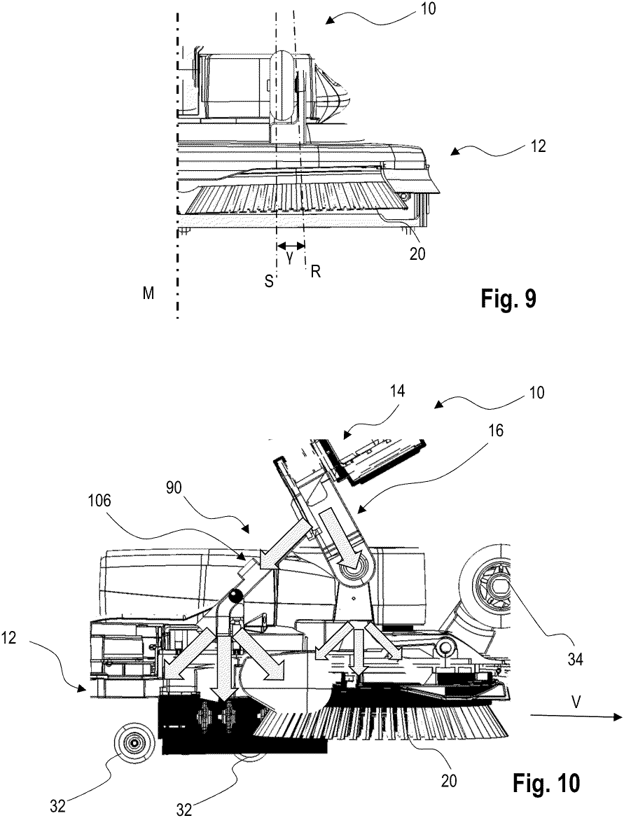

FIG. 9 is a detailed representation of the floor unit, explaining the inclination of the tool; and

FIG. 10 is a representation explaining the distribution of force from the guide member to the floor unit as conveyed by the joint assembly and the support device;

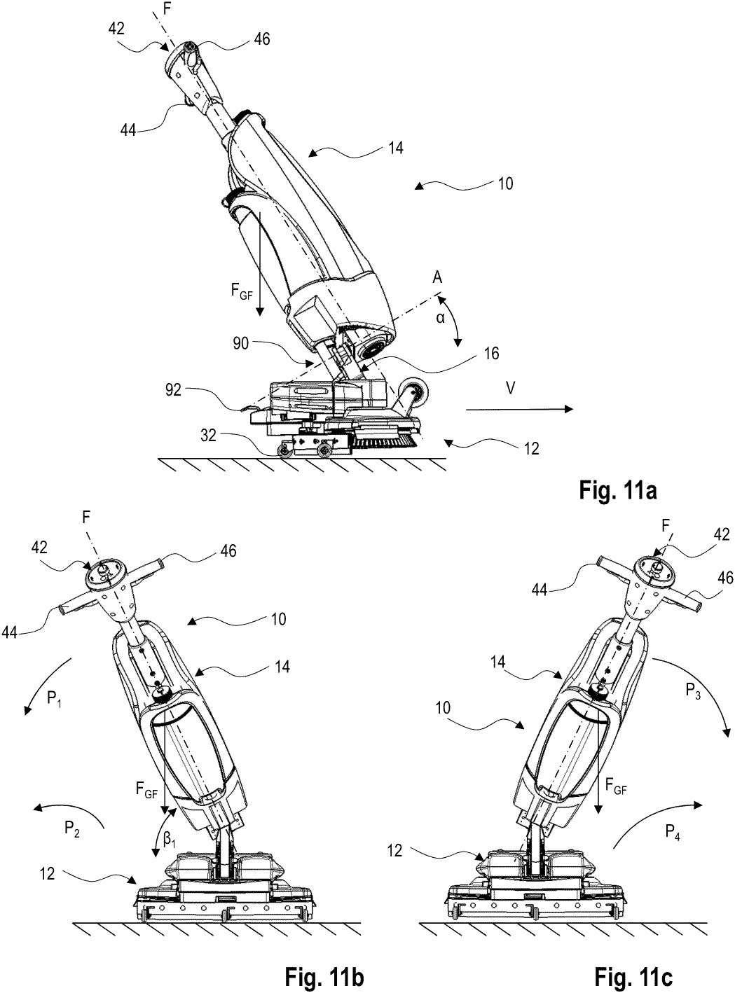

FIGS. 11a to 11c are detailed spatial representations generally explaining the maneuvering behavior of the floor cleaning device according to the invention;

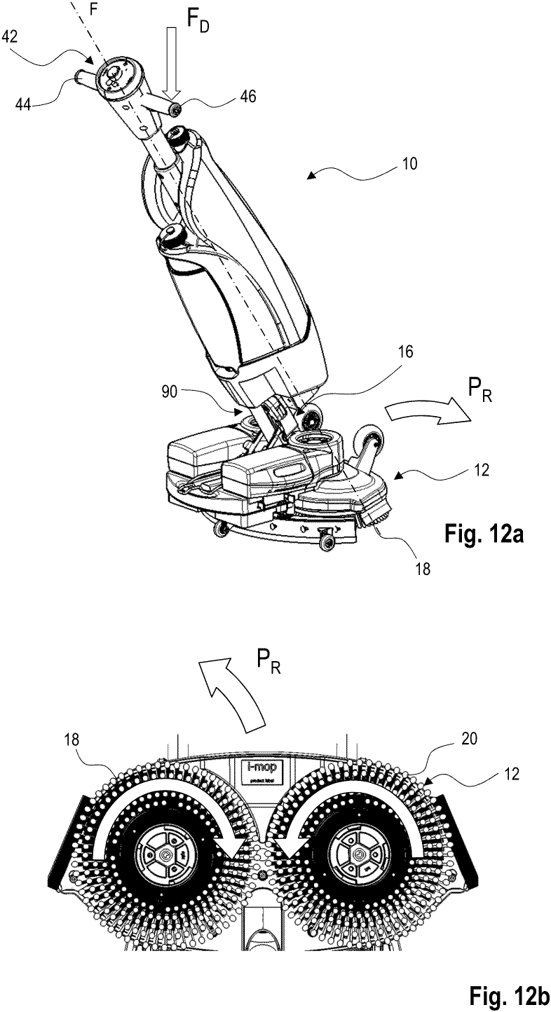

FIGS. 12a, 12b are spatial representations explaining a maneuvering operation with the floor cleaning device according to the invention where pressure is put on the operating arrangement at a handle on one side only;

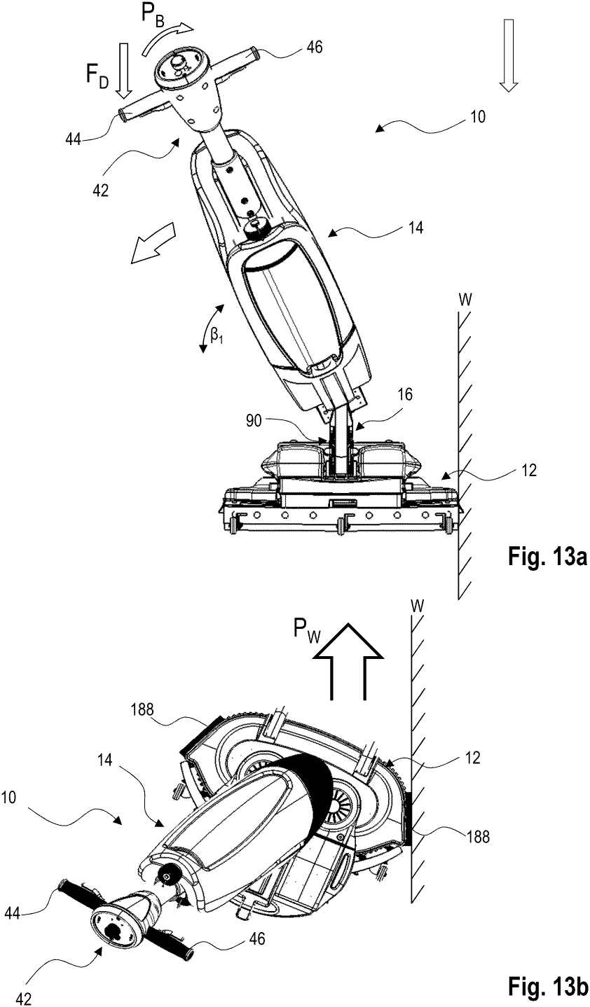

FIGS. 13a, 13b are spatial representations explaining a maneuvering operation with the floor cleaning device according to the invention where an operator moves it along a wall, keeping sufficient distance from the wall;

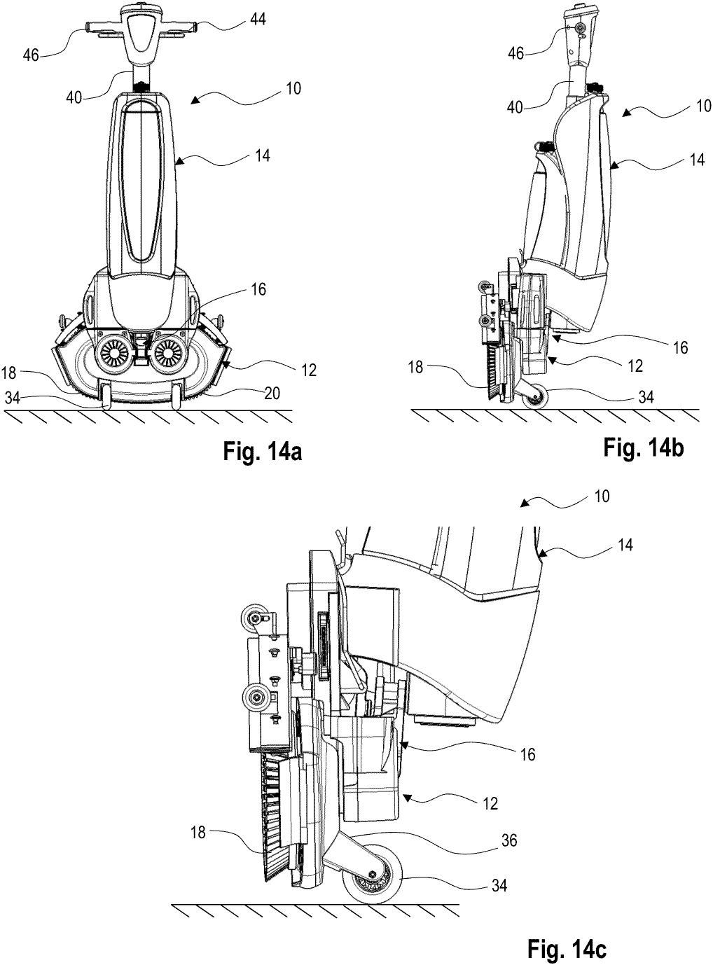

FIGS. 14a to 14c are detailed spatial representations explaining the parking position of the floor cleaning device according to the invention;

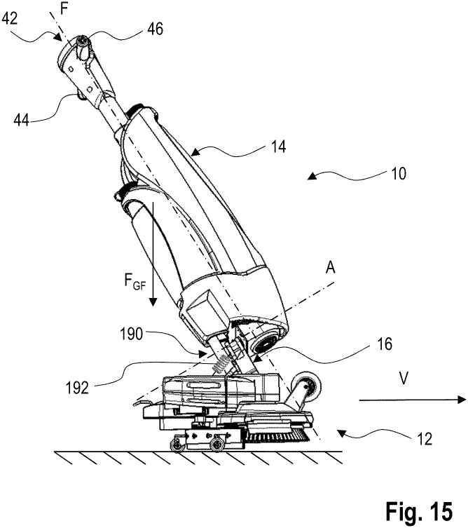

FIG. 15 is a spatial representation of a second embodiment of the floor cleaning device according to the invention with a spring-like support device;

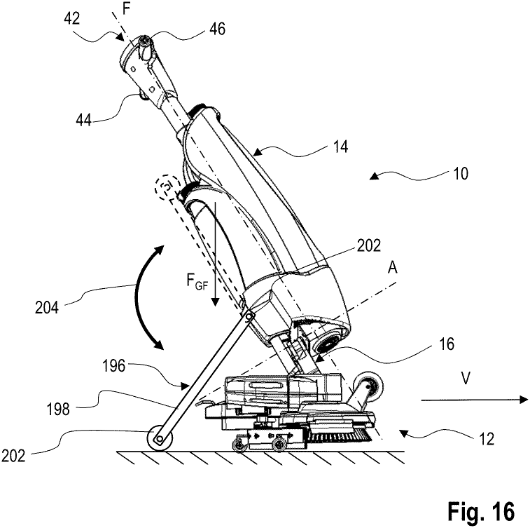

FIG. 16 is a spatial representation of a third embodiment of the floor cleaning device according to the invention with a foldable support device that is supported on the floor, if required;

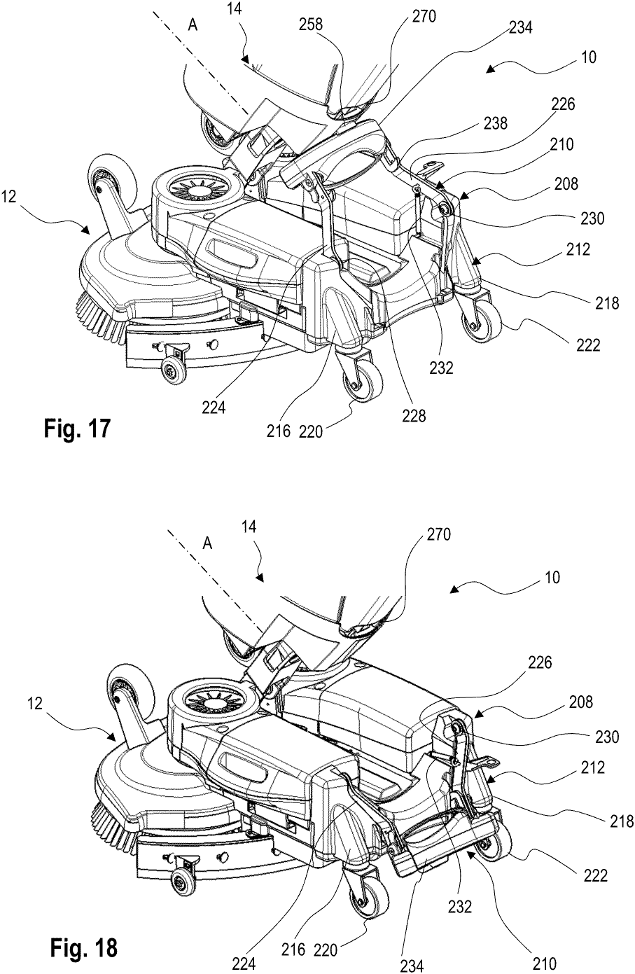

FIGS. 17 and 18 are spatial partial representations of a third embodiment of the floor cleaning device according to the invention with a support device enabling guided lateral pivoting of the guide member;

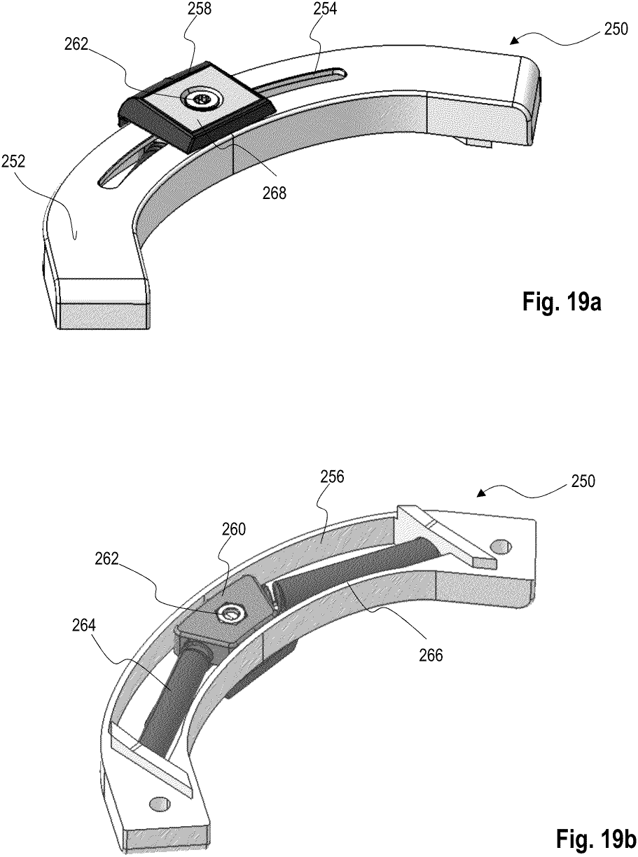

FIGS. 19a and 19b are individual representations of the base body of the support device of FIGS. 17 and 18;

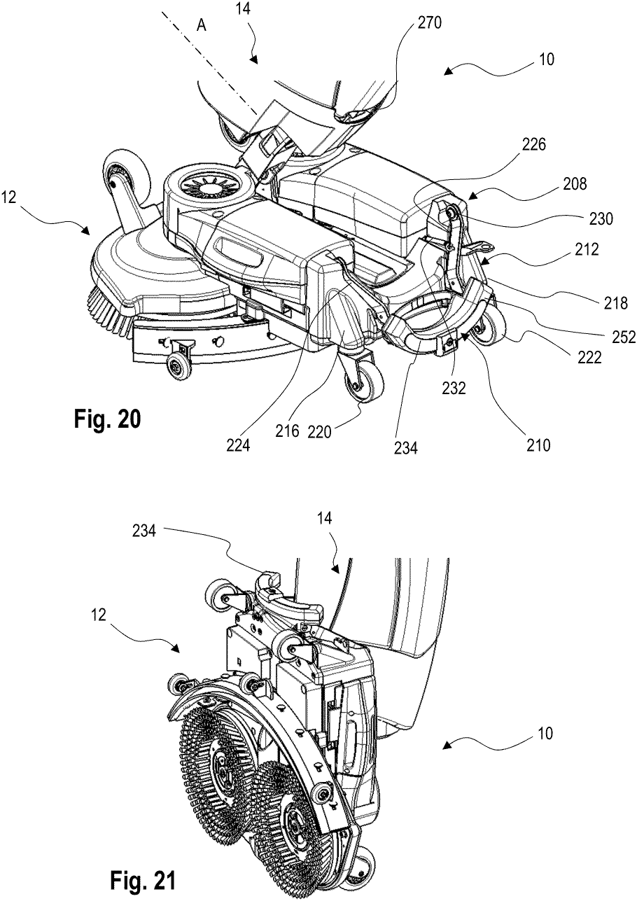

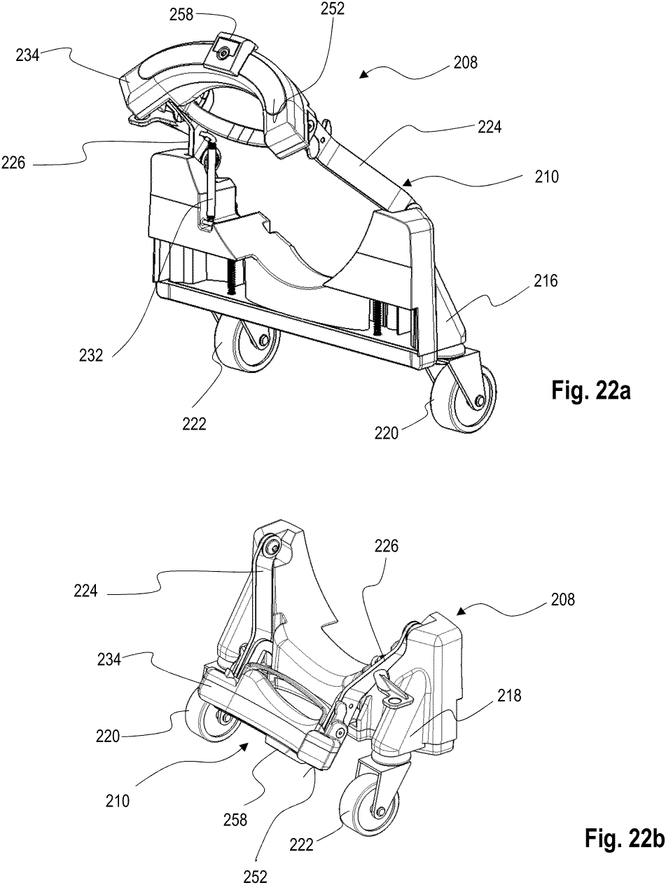

FIGS. 20 and 21 are spatial partial representations of the third embodiment with respect to different operating positions and parking positions of the support device, respectively; and

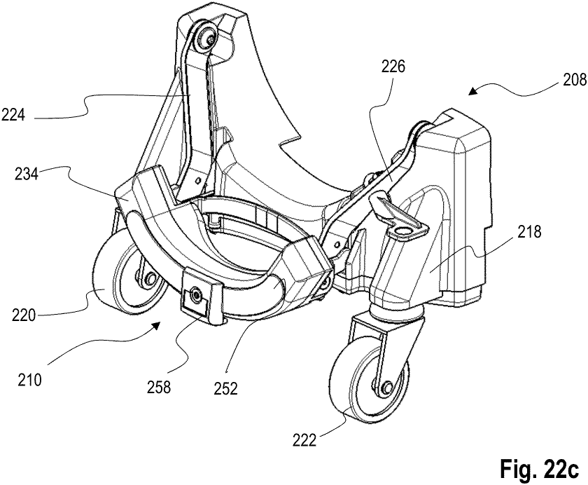

FIGS. 22a to 22c are spatial representations of a separate support module according to the third embodiment of the floor cleaning device according to the invention.

FIGS. 1 and 2 are spatial representations of a first embodiment of a floor cleaning device according to the invention, generally designated 10, from different perspectives. It comprises a floor unit 12 and a guide member 14 which are connected to one another in an articulate manner via a joint assembly 16.

Two brush-like tools 18, 20 that can be driven rotationally are assigned to the base unit. For this purpose, a drive arrangement 22 is assigned to the tool 18, and a drive arrangement 24 is assigned to the tool 20. The floor unit 12 comprises a plate-like housing 26 to which the two drive arrangements 22, 24 are attached, a free space being provided between them. The tools 18, 20 are supported on the underside of the housing 26. On the rear side of the housing 26, as can be seen in FIG. 1, a vacuum bar 28 is attached, on the underside of which a sealing lip arrangement 30 is provided, which is preferably formed from rubber-like material. It may comprise a single sealing lip or a plurality of sealing lips. A total of three support rollers 32 are provided on the rear side of the vacuum bar 28, one of which is concealed in the illustrations. On its front, the floor unit 12 further includes two transport rollers 34 that are upwardly inclined and supported in bearing projections 36. These transport rollers 34 serve to facilitate handling of the floor cleaning device 10 according to the invention in a storage position, which will be discussed in detail below with reference to FIGS. 14a to 14c.

The guide member 14 has an elongated shaft 40, to the upper end of which an operating arrangement 42 is attached. This operating arrangement 42 comprises two handles 44, 46 with assigned operating levers as well as a central control panel 48, on which a display or/and indicator panels are provided for displaying the current operating status as well as operating parameters, such as the current state of charge, current speeds of the tools 18, 20, filling levels for various liquids, such as fresh water, waste water, liquid cleaning agent, remaining operating time and similar information. The central control panel 48 further comprises adjustment instruments for switching on and controlling various operating parameters of the floor cleaning device 10, such as the speed of the tools 18, 20, or the like.

Further, a fresh water tank 50 with a filling nozzle 52 and a waste water tank 54 with a discharge nozzle 56 are provided on the shaft 40. The fresh water tank 50 may also be filled with a mixture of water and liquid cleaning agent. Alternatively, a separate tank for a liquid cleaning agent may be provided, which is not illustrated in the figures. Below the liquid tanks 50, 54, in a separate housing area 58, in a manner not shown in more detail, components are provided for supplying fresh water and liquid cleaning agent to the floor unit 12, as well as a vacuum unit, in particular including a vacuum turbine, for sucking in water containing liquid cleaning agent, which has been applied to the floor and absorbs dirt.

The inclination of the guide member 14 relative to the floor unit 12 is explained in the following on the basis of the inclination of the guide member longitudinal axis F which extends perpendicular to the first pivot axis A and runs through a line of action W defined by the center axis of the two handles 44, 46. Together with the first pivot axis A, the guide member longitudinal axis spans a plane of inclination of the guide member 14 relative to the floor surface.

The joint assembly 16 connecting the floor unit 12 to the guide member 14 is described in more detail below with reference to FIGS. 3 and 4. In the embodiment shown, it comprises a first bearing member 60 attached to the floor unit, a joint member 62 coupled to the first bearing member 60, and a second bearing member 64 attached to the underside of the shaft 40 of the guide member 14.

The joint assembly 16 is configured such that the second bearing member 64 is pivotable about a first pivot axis A relative to the joint member 62. In the position according to FIGS. 1 to 4, which corresponds approximately to an operating position in which the floor cleaning device 10 according to the invention is maneuvered for cleaning a floor, hereinafter also referred to as the maneuvering operating state, the first pivot axis A extends diagonally forward. It is in a plane, i. e. a first pivot axis plane, together with a direction of advance V parallel to the floor, which is substantially on a line of symmetry between the two tools 18 and 20 perpendicular to the floor surface. Further, the joint assembly 16 comprises a second pivot axis B which is orthogonal to the first pivot axis A. The joint assembly 16 with its joint member 62 thus connects the floor unit 12 to the guide member 14 like a double universal joint assembly.

In detail, in its lower area for coupling to the first bearing member 60, which is attached to the floor unit 12, the joint member 62 comprises a fork shape including two struts 68, 70 which are connected to each other at the rear through a reinforcing member 72. A bearing bolt 74 extends through the two struts 68, 70 and supports the joint member 62 on the first bearing part 60 such that it can be pivoted about the pivot axis B. At its upper end, the joint member 62 comprises a bearing eye 76 that is configured in a conically tapered portion and defines the first pivot axis A. Via this bearing eye 76 and an associated bearing bolt, the joint member 62 is connected to the second bearing member 64 at the lower end of the shaft 40 of the guide member 14 so as to be pivotable about the first pivot axis A.

The first bearing member 60 is displaceable on the floor unit 12 along a guide rail 80 and lockable in any position along the guide rail 80. This is done by means of a clamping mechanism which can be released for displacement and brought into a clamping position for fixing. Alternatively, predetermined locking positions may be provided in which the first bearing member can be fixed, for example, by insertion into predetermined locking or latching openings. This adjustment possibility helps to change and fix the mechanical point of engagement of the guide member on the floor unit as desired, which can influence the maneuvering properties of the floor cleaning device 10 according to the invention. This will be discussed in detail in the following.

As illustrated in FIGS. 1 and 2, a free space is provided between the two drive arrangements 22 and 24 at the rear. On the one hand, this serves to provide sufficient space for the guide member 14 to be locked in place along the rail 80 as desired without colliding with the drive arrangements 22, 24. On the other hand, a support device 90 is provided in this free space, of which an adjustable locking bracket 92 is substantially visible in FIGS. 1 and 2. The support device 90 is shown in detail in FIGS. 5 and 6, and its functionality is explained in the following, in particular with reference to the detailed illustrations of FIGS. 7 and 8.

The support device 90 includes a base 94, by means of which it is supported on the plate-shaped housing 26 of the floor unit 12. The base 94, too, is displaceable along the rail 80 as desired. The base 94 has two lateral bearing jaws 96, 98 extending upwardly from the base 94. In the bearing jaws 96, 98, on the one hand, the aforementioned locking bracket 92 is pivotably received, wherein two free ends of the locking bracket 92 directed towards each other serve as bearing bolt sections. The locking bracket 92 extends from the bearing jaws 96, 98 in a multiply angled or curved shape to an angled U-shaped section 100, wherein this angled U-shaped section 100 is connected to the bracket portions 104 extending from there through two support portions 102. It is understood that the locking bracket 92 may be configured differently.

A receiving fork 106 which is also pivotable within the bearing jaws 96, 98 is attached to the inside of the two bearing jaws 96, 98. The receiving fork 106 is U-shaped and has two longitudinal legs 108 pointing diagonally upwards away from the base 94 with their rounded free ends 110 which have a slight inward offset. Additional laterally projecting contact tongues 112 are provided on the two legs 108. The transverse leg 114 is relatively solidly configured and serves to provide supporting contact with the base 94.

A holding magnet 116 is provided in the base 94 between the two bearing jaws 96, 98.

Furthermore, FIG. 5 as well as the previously described FIGS. 3 and 4 illustrate a fixing member 120 which is provided for fixing to the joint member 62 and has a bearing opening 122 which can be brought into alignment with the bearing eye 76. The fixing member 120 is adapted to the geometry of the upper portion of the joint member 62, has a plate-like shape with stabilizing reinforcing ribs 124 and, in its lower region in FIG. 5, is provided with receiving openings 126 into which the rounded ends 110 of the legs 108 can penetrate and be received in a supporting manner.

Both the locking bracket 92 and the guide fork 106 are pivotable about a third pivot axis C relative to the base. The third pivot axis C is substantially parallel to the second pivot axis B.

The functionality of the support device 90 will be discussed below. FIG. 7 shows the support device 90 in a state in which the locking bracket 92 is folded down backwards so that the locking bracket 92 is in a passive position, resting on the housing 26 of the floor unit 12 in the space between the two drive arrangements 22, 24. In this position of the support device 90, the entire weight of the guide member 14 is supported on the floor unit 12 solely by the action of the support device 90 with the receiving fork 106 and by the connection through the joint assembly 16. Thus, an operator no longer has to bear the entire or some of the weight of the guide member. In this state, the floor cleaning device 10 - as long as the guide member 14 is not tilted sideways - remains completely stable on its own, not needing any support from the user. When the guide member 14 is tilted sideways, the operator needs to partially support the weight of the guide member.

It may be an optional additional feature that the base 94 can also be moved into and fixed at various distances and in relative positions along the rail 80 relative to the joint assembly 16. This makes it possible for the receiving fork 106 to be brought into different pivot positions relative to the bearing jaws 96, 98 and thus to support the guide member 14 in different angular positions relative to the floor unit 12. This also leads to different orientations of the first pivot axis A with respect to its inclination relative to a floor surface.

However, it is also important that in the position shown in FIG. 7, the support device continues to allow the guide member to pivot about the first pivot axis A without hindrance. Although in the state shown in FIG. 7, in which the guiding part 14 is in a neutral position, i.e. pivoted about the pivot axis A neither to the left nor to the right, the entire weight of the guide member 14 is transferred to the floor unit 12 via the support device 90 and the joint assembly 16 so that the user need not hold the guide member 14 themselves and in the embodiment shown not even to some extent, the user can maneuver the floor cleaning device 10 by actively pivoting the guide member about the pivot axis A to the left or to the right with little effort despite having to bear some of the weight of the guide member 14, depending on the degree of pivoting. Pivoting in combination with the support considerably improves the maneuvering properties, as will be explained below with reference to FIGS. 11a to 11c.

The support device 90 further has the function of additionally locking the floor cleaning device 10 against pivoting about the pivot axis A in the position shown in FIG. 8.

FIG. 8 shows the support device 90 in a state in which the locking bracket 92 is folded upwards so that the U-shaped section 100 is received in a housing recess 130 in the lower housing portion 58 of the guide member 14. In this position, the substantially positive reception of the U-shaped section 100 of the locking bracket 92 in the housing recess 130 of the guide member 14 prevents the guide member 14 from pivoting about the pivot axis A. Pivotable in its position, the locking bracket 92 creates a kind of selectable locking function. Such locking function allows the floor cleaning device 10 to be temporarily parked safely without the user having to hold or stabilize any components.

It is further to be noted that the support device 90 shown in FIGS. 5 and 6 can also be provided and used as a separate component for retrofit purposes. It is thus possible to retrofit such a component to already known cleaning devices, all of which have the problem that the operator has to take over and carry at least some of the weight of the guide member while maneuvering during operation, which is exhausting and tiring in the long run. Such a retrofit support device may be configured with the receiving fork 106 alone, or with a suitably configured device for receiving the weight of the guide member 14, or it may additionally be provided with the pivotable locking bracket 92.

When the floor unit 12 is viewed from the front, FIG. 9 shows that the tool 20 is rotatable about an axis of rotation R, this axis of rotation R being inclined inwardly relative to a perpendicular S at an inclination angle y. Similarly, but mirrored about a central axis M, the tool 18 (not illustrated in FIG. 9) is inclined inwardly. When the two tools 18 and 20 are driven in opposite directions about the respective axes of rotation R, an advance effect is achieved in the direction of the direction of advance V.

In FIG. 10, the arrows show that as soon as the support device 90 is effective, the weight force of the guide member 14 is introduced into the floor unit 12 not only via the joint assembly 16 but equally also via the support device 90 and in particular via the receiving fork 106. Due to the more even distribution of the weight of the guide member 14, the rear rollers 32 absorb somewhat more force and have a somewhat greater support effect. This relieves the brush-type tools 18, 20 to some extent, which can extend their service life. If such brush relief effect is not desired, an embodiment of the present invention may provide that the joint assembly is arranged on the floor unit rather further forward in the direction of advance. The support device can then be arranged further back against the direction of advance. This helps to achieve a more even or central distribution of the weight force of the guide unit on the floor member. In addition, the advantages mentioned above and explained in detail below with regard to maneuvering and ease of use are achieved.

FIGS. 11a to 11c illustrate various maneuvering states in which the support device 90 described above comes into play in a particular manner.

FIG. 11a is a side view of the floor cleaning device 10 according to the invention, showing how the guide member 14 is pivoted backwards towards an operator (not illustrated) relative to the floor unit 12 by means of the joint assembly 16 in such a way that the first pivot axis A extends at an angle a of about 30° relative to a ground to be cleaned. In this state, the support device 90 fully supports the weight force F_{GF} of the guide member 14 so that an operator need not bear this weight force F_{GF}. The operator can, with very little effort, pivot the guide member 14 to the left and to the right to maneuver, engaging the handles 44 and 46 of the operating arrangement 42 and maneuvering the floor cleaning device 10 via the handles. Depending on the degree of pivoting, the operator must bear the weight of the guide member 14 proportionately.

To maneuver, the operator can in particular, as shown in FIGS. 11b and 11c, pivot the guide member 14 of the floor cleaning device 10 to the left about the first pivot axis A, as shown by arrow P₁. This displaces also the center of gravity of the guide member 14 slightly to the left. As a consequence, the force balance shifts and a moment occurs in the floor unit 12 about the vertical axis of the floor unit, which is essentially perpendicular to the floor, also called yaw moment. This effect is aided by the fact that the floor unit 12 can be maneuvered relatively easily on the ground anyway due to the counter-rotating tools 18, 20 as well as due to the effect of the support rollers 32 and pushes forward in the direction of advance V due to the advance effect of the drive of the counter-rotating tools 18, 20. Consequently, as a result of the deflection of the guide member 14 according to the arrow P₁ in combination with the advance effect and the resulting yaw moment, the floor cleaning device steers to the left in the direction of arrow P₂ extremely smoothly.

This effect is also aided by the operator counteracting the advance effect of the floor unit 12 by, for example, lightly holding the handles 44, 46 of the operating arrangement 42, increasing the steering effect and yaw moment in the process. For example, the operator may hold the left handle 44 shown in FIG. 11b at the inclination shown or even pull it slightly backward against the effect of the advance force, pushing the right handle 46 slightly forward, thereby applying torque to the floor unit 12 through the double universal joint assembly 16. This results in a cornering action that can be used to advantage while maneuvering. As a further supporting effect, the advance effect does not act evenly on the floor member but is stronger on the right-hand side of the floor unit 12 due to the horizontal force component of the guide member 14 that is introduced into the floor unit 12. This additional effect pushes the floor unit 12 more strongly to the left.

However, it is also possible to move completely straight ahead in such an inclined position of the guide member 14, for example along a wall or underneath a protrusion, such as a piece of furniture under which the floor unit is moving. Inclined sideways, the guide member 14 allows the operator to walk at a safe distance from the wall or protrusion. The operator should not counteract when moving straight ahead with the guide member 14 inclined to not subject the floor unit 12 to a moment. In this way, for example, the brush surface of the tools 18, 20 can be utilized to the maximum and an optimum cleaning effect can be achieved even close to a wall or under overbuilt surfaces. It is important, however, that the operator does not counteract or pull the guide member 14 towards themselves when moving straight ahead as described.

In all these maneuvering situations, however, the support device according to the invention offers the advantage that it absorbs the entire weight force F_{GF} of the guide member 14 or at least a small to a large part of it and transfers it to the floor unit 12. In any maneuvering situation, the operator is thus already slightly or even considerably relieved. Accordingly, the floor cleaning device 10 according to the invention is much easier to operate and control, even in the case of long cleaning processes. By slightly tilting the floor cleaning device 10 backwards using the support device or by holding the floor cleaning device 10 against the direction of advance, the operator can additionally influence the advance effect.

FIG. 11c shows an analogous control movement by deflecting the guide member 14 to the right according to arrow P₃, so that a corresponding cornering action to the right follows according to arrow P₄.

This type of control can be dosed by selecting different inclination angles β, i.e. a large inclination angle β causes a relatively strong cornering movement with a small curve radius, whereas a small inclination angle β makes the cornering movement less strong with a larger curve radius. Further possibilities for influencing this movement are the intensity of the operator’s counteraction but also the magnitude of the advance effect caused by the rotating tools 18, 20.

Another option to influence the maneuvering properties is to adjust the position of the joint assembly 16 on the floor unit 12, as indicated above. Thus, the joint assembly 16 can be moved forward and backward along the rail 80 on the floor unit 12, which changes the kinematics and maneuvering behavior of the floor cleaning device 10 according to the invention. As a rule of thumb, the floor cleaning device 10 according to the invention can be steered more neutrally if the center of gravity of the guide member 50, on which the weight force F_{GF} acts, is arranged in alignment with or only at a slight horizontal distance (when viewed from above, i.e. in horizontal projection onto the floor surface) from the center of gravity of the floor unit 12. In contrast, when the distance is increased, the floor cleaning device 10 reacts more sensitively to deflection movements. However, by shifting the joint assembly 16 further back along the rail 80 on the floor unit 12, the cleaning tools 18, 20 are relieved and do no longer push down too hard on the ground. This also applies to the aforementioned tilting of the guide member against the effect of the support device. This allows the cleaning intensity to be influenced, for example in the case of sensitive ground surfaces. In addition, wear of a tool 18, 20 can be reduced. The weight force F_{GF} then weighs more heavily on the support rollers 32.

For the sake of completeness, it is to be noted that the deflection movements according to FIGS. 11b and 11c can be completely blocked with the locking bracket 92, which facilitates a permanent straight-ahead movement of the floor cleaning device 10. Also, the locking bracket 92 may be configured to allow only small deflection at small angles β1 and β2.

FIGS. 12a and 12b show a maneuvering operating state in which an operator exerts a kind of pressure force F_{D} on the handle 46 of the operating arrangement 42 from above only on one side and releases the other handle 44 or at most holds it for guidance rather than exert a corresponding pressure force on it. This measure causes the guide member 14 to tilt slightly about the first pivot axis A and/or a slight counteraction by the operator. Correspondingly, unbalanced pressure conditions as conveyed by the support device 90 and the joint assembly 16 act in the floor unit 12, resulting in a transverse force in the floor unit 12. As shown in FIG. 12a, there is a cornering movement to the right with respect to the direction of advance according to the arrow P_{R} (in the bottom view, the arrow P_{R} logically points to the left). Rotating the handle 46 itself or the operating arrangement 42 as a whole about the axis F is not necessary. In this exemplary maneuvering situation, simply by putting pressure on the handle 46 and a related light counteraction by the operator, a simple control movement can be initiated without much effort on part of the operator, conveyed by the support device 90 and in interaction with the advance.

FIGS. 13a and 13b show a maneuvering situation in which the operator steers the floor cleaning device 10 along a wall W (possibly under a protrusion), having pivoted the guide member 14 laterally to the left relative to the floor unit 12 as viewed from the rear, approximately to an inclination angle β of about 70°. The bottom unit 12 is further inclined at a slight angle to make the best possible use of the brush surface of the tools 18, 20. The floor unit 12 is steered along the wall W with a sliding surface 188 that is gentle on the surface, i.e. parallel to the wall as indicated by the arrow Pw. This is made possible by slightly turning the operator’s arrangement 42 (see arrow P_{B}) and applying slight pressure force to the handle 44 from above (see force F_{D}). This maneuver helps to achieve a favorable force distribution in the floor unit 12 to the counter-rotating tools 18, 20 as conveyed by the support device 90. Thus, the floor cleaning device 10 can be easily maneuvered along and parallel to the wall W without little effort on the part of the operator.

The pictures also show that the floor cleaning device 10 can be turned at will, for example by 90 or 180°, without any effort, almost playfully, without the guide member 14 coming into contact with the wall when the operator is approaching a wall.

FIGS. 14a to 14c show that the floor cleaning device 10 according to the invention can be brought into a storage or transport position that saves space and makes transport easier. As can be seen from the figures, the floor unit 12 can be pivoted relative to the guide member 14 with the joint assembly 16 and locked in this position in such a way that the bearing projections 36 protrude diagonally forward and the transport rollers 34 are substantially in vertical alignment with the shaft 40 of the guide member 14. Thus, by gripping the handles 44, 46, the floor cleaning device 10 can be easily moved on the transport rollers 34 without the tools 18, 20 being in contact with the ground. The floor cleaning device can also be easily parked in this way, for example. If necessary, the floor unit 12 can be returned into the operating position shown above.

FIG. 15 shows a second embodiment of the invention. Here, the support device 190 is configured only as a compression spring 192, as schematically indicated. This has the effect that at least some of the weight force F_{GF} of the guide member 14 is absorbed by the spring when the guide member 14 pivots about the second pivot axis B. The greater the pivoting movement of the guide member 14, the stronger the support effect of the spring 192. It may also go to block to completely support the guide member 14. In addition or alternatively, a stop can be provided to achieve complete support when the first pivot axis A is pivoted by a certain angle a (see, for example, FIG. 11a).

The design of the support device 190 in the form of a compression spring 192 or an assembly comprising such a compression spring 192 is particularly simple and inexpensive.

An alternative embodiment, which is not shown in more detail in the drawing, comprises a support device in the form of a single lever which cannot be pivoted about a pivot axis extending transversely to the direction of advance V but rather can be folded away laterally about a pivot axis, this pivot axis extending essentially in the direction of the direction of advance or at an acute angle to it. The support device can be configured to provide a support surface for the guide member, on which the guide member is pivotable about the first pivot axis A but cannot be pivoted any further about the second pivot axis B upon contact between the guide member and the support surface. In such case, it is also possible to design the floor cleaning device with only one pivot axis, i.e. the second pivot axis, so that the guide member can simply be temporarily placed on the support device for support.

In this context, it is possible, for example, to provide a hollow on the guide member with which the support device, in particular the foldable lever, engages when the guide member is placed on it. This hollow can accommodate the lever in a fitting manner or also permit a relative pivoting movement of the guide member relative to the floor unit about the first pivot axis.

As an alternative to a support device with a bearing surface that allows for the guide member to pivot about the first pivot axis A while the guide member is sliding on the bearing surface, in a further embodiment of the invention the support device provides for positive and/or non-positive engagement or interaction of the support device with the guide member so that any pivoting movement of the guide member relative to the floor unit is temporarily prevented. In this embodiment, the guide member cannot be pivoted about either the first or the second pivot axis when the support device engages with the guide member. For example, a recess or hollow can be provided on the guide member or on the floor unit with which the support device engages positively or at least partially positively and thus provides support while restricting the relative movement of the two components with respect to each other.

Another alternative embodiment, which is not shown in detail in the drawings, comprises, for example, a joint assembly between the floor unit and the guide member, which is configured as a spring element, for example as a flexible rubber body or as a unit comprising metallic spring elements. It is possible to provide any pivot direction with a spring action.

Embodiments of the invention may also provide that the support device is rigid, for example in the form of a rod, similar to the embodiment shown in FIG. 15. It is also possible to use a cable pull or a spring-loaded cable pull as a support device, for example in such a way that the cable pull is arranged in front of the joint assembly in the direction of advance, blocking further pivoting about the second pivot axis B from a certain angular position of the guide member relative to the floor unit while allowing the guide member to pivot about the first pivot axis. As an alternative to a cable pull, a tension spring may be provided, which is lockable to the floor unit in front of the joint assembly in the direction of advance.

According to a further embodiment of the invention, shown in FIG. 16, a support device 196 can be provided on the guide member 14, which supports the guide member 14 from a certain angle of the first pivot axis A relative to the floor or in a certain angular range directly on the floor. This can be, for example, a double-legged fork 198 whose upper end is pivotally supported on the guide member 14 via pins 200. At its lower end, rollers 202 may be arranged on the fork 198, which roll on the floor during operation of the floor cleaning device 10, providing support.

According to the arrow 204, the support device 196 can be pivoted between the supporting operating position indicated by a solid line in FIG. 16 and a parking position indicated by a dashed line. The support device 196 can be locked, possibly spring-loaded and/or damped, in the operating position and in the parking position and possibly also in intermediate positions. In the operating position in which the guide member 14 is supported, the operator is relieved by not having to bear the weight of the guide member 14 via the handles 44, 46 and can rather hold the handles 44, 46 just to maneuver the cleaning device 10 with slight movements. Slight counteraction at one of the handles 44, 46 produces the effects described above for generating torque in the floor unit 12.

FIGS. 17 to 22 show a further embodiment of the present invention in which a separate support module 208 including a pivotable support device 210 is provided on the floor unit 12. The components of the floor unit 12 and the guide member 14 described above are not described again, neither are the reference signs indicated. In particular, the differences between this embodiment and the preceding embodiments will be discussed.

This pivotable support device 210 is provided on a base body 212 of the support module 208. The support module 208 can be modularly attached to the floor unit 12 of an existing floor cleaning device 10 via a predetermined coupling interface. For example, the support module 208 may be purchased as an add-on component for retrofitting an existing floor cleaning device 10 and attached to it permanently or as needed.

It can be seen that the base body 212 is configured with a housing 214. As shown in FIGS. 17 and 18, it has two extensions 216, 218 at the rear on which rollers 220, 222 are rotatably supported so as to be pivotable about a vertical axis in each case. The rollers 220, 222 serve to support the floor cleaning device 10 behind the vacuum bar. They align themselves automatically during maneuvering of the floor cleaning device 10.

In FIGS. 22a, 20b and 22c, the support module 208 is separate and detached from the floor cleaning device 10. The floor cleaning device can be detachably connected to this base body 212 via the specifically designed interface.

The support device 210 includes two levers 224, 226 pivotally attached to the base body 212 of the support module 208. The levers 224, 226 are pivotally supported on the base body 212 via pivot bolts 228, 230. Further, at least one of the levers 224, 226 is spring-biased in two predetermined positions by a tension spring 232, which will be described in further detail below. At the end that is away from the bearing on the base body 212 via the pivot bolts 228, 230, a bearing member 234 is attached to the two levers 224, 226. It, too, is pivotable relative to the levers 224, 226 via pivot bolts 230 and latchable in the position shown in FIG. 17 via a latching hook 238.

A comparison of FIG. 17 and FIG. 18 shows that the support device 210 itself can be pivoted between a support position (FIG. 17) and a parking position (FIG. 18). By suitably selecting the pivot point 240 of the tension spring 232 on the housing 214 of the base body 212 relative to the pivot axis of the two levers 224, 226 defined by the pivot bolts 228, 230, as shown in FIGS. 17 and 18, the pivotable support device 210 is biased both in the support position (FIG. 17) and in the parking position (FIG. 18). When the support device 210 is pivoted from one position to the other, the tension spring 232 is initially tensioned, reaches a temporary maximum tensioned state, and then relaxes again upon further pivoting movement in the direction of the respective desired target position. The same applies to pivoting in the opposite direction. This ensures that the support device 210 remains reliably and spring-biased in the desired position.

Turning to the bearing member 234 as shown in detail in FIGS. 19a and 19b, it can be seen that the member has an arcuate base body 250 comprising a largely closed surface 252 with an arcuate guide aperture 254 on its upper side as shown in FIG. 19a. On the underside (see FIG. 19b), the base body 250 is provided with a recess 256. In the guide aperture 254, a guide carriage 258 is guided which can be moved within the guide aperture 254 along an arcuate trajectory predetermined by the latter and slides on the surface 252 of the base body 250 in the process.

FIG. 19b shows that the guide carriage 258 is secured to a trapezoidal counter-body 260 via a screw connection 262 within the recess 256, wherein the counter-body 260 moves within the recess 256 with the guide carriage 258. Spring elements are provided on both sides of the trapezoidal counter-body 260, in the present case compression springs 264, 266, which bias the guide carriage 258 together with the counter-body 260 into a central position within the guide aperture 254 or the recess 256. The guide carriage 258 can be moved along an arcuate trajectory within the aperture 256 against the action of this spring arrangement comprising the two compression springs 264, 266. The guide carriage 258 has a metallic plate 268 on its upper side, which may be magnetic and serve for temporary coupling to the guide member 14.

FIG. 17 shows how the guide member 14 rests on the guide carriage 258. For this purpose, positive engagement may be provided, for example in such a way that a recess 270 (see FIGS. 17 and 18) is provided in the center of the guide member 14, which receives the guide carriage 258 substantially positively. If necessary, a supporting non-positive connection may be provided through a magnet arrangement by means of the metal plate 268. As a result, the guide member 14 is detachably temporarily coupled to the guide carriage 258. This allows the guide member 14, guided by the guide carriage 258 on the bearing member 234, to be pivoted to the left and right about the first pivot axis A, wherein pivoting taking place against the resistance of the spring arrangement comprising the two springs 264, 266. A return of the guide member 14 to a central neutral position is assisted by the spring arrangement. The support device 210 acts as described above with respect to the other embodiments according to the invention. It relieves the operator from having to bear the full weight of the guide member 14 via the two handles 44, 46, and further facilitates maneuvering in the manner described in detail above.

Turning to the parking position of the support device 210, it can be seen that in this parking position, the bearing member 234 can again assume two different positions, namely the position as shown in FIG. 18 with the surface 252 of the bearing member 234 pointing downwards, and the position as shown in FIGS. 20 and 21. The position as shown in FIG. 18 comes with the advantage that the bearing member 234 is already in the correct orientation when being pivoted upwards into the operating position for supporting the guide member 14.

Starting from the position shown in FIG. 18, the bearing member 234 can additionally be pivoted into the parking position shown in FIG. 20, in which it is folded upwards relative to the levers 244, 226 in a space-saving manner. Viewed from the cleaning device 10, the surface 252 then faces rearward. In this position, the bearing member 234 can be arranged to save space. This position according to FIG. 20 is particularly suitable for moving the cleaning device 10 into its parking position according to FIG. 21, as described in detail above with reference to FIGS. 14a to 14c.

FIGS. 22a to 22c are various views again showing the separate retrofittable support module 208 separately. In FIG. 22a, the support device 210 is shown in its operating position according to FIG. 17 for support, in FIG. 22b, the support device 210 is shown in the folded position according to FIG. 18, and in FIG. 22c, starting therefrom, the support device 210 is shown in its parking position, wherein the bearing member 234 is also pivoted relative to the levers 224, 226.

This embodiment can provide a support module 208 that can be retrofitted or attached to a cleaning device 10 as needed.

It is to be noted that the support devices according to the present invention or the joint assembly may additionally be configured with damper elements to dampen vibrations or to avoid a stop that is too abrupt. Such dampers can be, for example, pneumatic or hydraulic dampers or simply be configured in the form of a damping rubber body. The invention has the advantage that, by means of the support device in its different designs according to the various embodiments, the weight force of the guide member 14 can be completely or at least partially transferred to and taken over by the floor unit 12 in a plurality of maneuvering situations, so that an operator can maneuver the floor cleaning device 10 according to the invention much better. Reference is made to the above explanations in the introduction to the specification and in the description of the figures.

By simple tilting movements and balanced or different pressure force distribution at the operating arrangement 42, in particular at the handles 44, 46, the floor cleaning device 10 can be easily handled in different maneuvering situations by utilizing the advance effect of the counter-rotating tools 18, 20 which are slightly inclined with respect to the floor surface. Tilting movements of the guide member 14 to the left, to the right, to the rear (towards the operator) and to the front (away from the operator) are easy to perform as long as the support device is not engaged. As soon as the support device in its different designs is engaged, beneficial maneuvering movements can be performed due to suitable power transmission (see above explanation) without great effort on part of the operator.

What is claimed is:

1. A floor cleaning device, in particular a scrub vacuum floor cleaning device, comprising:
a floor unit which is assigned a direction of advance parallel to a floor surface to be cleaned,
a tool which is assigned to the floor unit and which, in an operating state, contacts the floor surface, the tool being movable relative to the floor surface by means of a drive;
a guide member for guiding the floor cleaning device; and
a joint assembly connecting the floor unit and the guide member in an articulate manner;
wherein the floor cleaning device is configured to produce an advance effect with respect to the floor surface in the direction of advance,
wherein the joint assembly is configured with a first pivot joint having a first pivot range with a defined or virtual first pivot axis and allowing a pivot movement of the guide member relative to the floor unit about the first pivot range, in particular about the first pivot axis,
wherein the first pivot axis is in a first pivot axis plane which is perpendicular to the floor surface and contains a direction vector defining the direction of advance,
characterized in that in a maneuvering operating state, the guide member can be pivoted about the first pivot axis relative to the floor unit, wherein the guide member can be fixed or temporarily supported in the first pivot axis plane relative to the floor unit or to the floor, wherein, as a result of the pivoting movement of the guide member about the first pivot axis, with the support of the guide member in the pivot axis plane being conveyed, the advance effect brings about a moment of rotation of the floor unit on the floor surface that benefits the maneuvering of the floor cleaning device.

2. The floor cleaning device of claim 1, characterized in that in the maneuvering operating state, the first pivot axis and the direction vector defining the direction of advance enclose an acute angle ranging between 5° and 85°, preferably between 15° an 45°.

3. The floor cleaning device of claim 1, characterized in that the first pivot joint is permanently fixable to the floor unit about the first pivot axis or lockable in predetermined positions providing for the alignment of the first longitudinal axis with the direction vector defining the direction of advance in the maneuvering operating state.

4. The floor cleaning device of claim 1, characterized in that the joint assembly is configured with a second pivot joint having a second pivot range with a defined or virtual second pivot axis and allowing a pivot movement of the guide member relative to the floor unit about the second pivot range, wherein the second pivot axis is substantially parallel to the floor surface and transverse to the first pivot axis.

5. The floor cleaning device of claim 4, characterized in that the joint assembly is functionally assigned to a support device which, in the maneuvering operating state, supports the guide member or the joint assembly with the first pivot joint relative to the floor unit or relative to the floor at least temporarily or/and at least partially.

6. The floor cleaning device of claim 5, characterized in that the support device is lockable at least temporarily in at least one locking position, preferably in at least two, particularly preferably in at least three locking positions.

7. The floor cleaning device of claim 5, characterized in that the support device is continuously lockable.

8. The floor cleaning device of claim 5, characterized in that the support device is rigid.

9. The floor cleaning device of claim 5, characterized in that the support device comprises a spring element having a support effect, preferably a progressive support effect, depending on the angle between the first pivot axis and the direction vector defining the direction of advance.

10. The floor cleaning device of claim 5, characterized in that a damper element is assigned to the support device.

11. The floor cleaning device of claim 4, characterized by a support device which is assigned to the first pivot range with its first pivot axis and is configured to at least partially support the guide member when pivoting about the first pivot axis with respect to the floor unit from a predetermined or predeterminable pivot angle.

12. The floor cleaning device of claim 1, characterized in that the support device is configured to support or guide the guide member when pivoting about the first pivot axis with respect to the floor unit preferably along an arcuate path.

13. The floor cleaning device of claim 11, characterized in that the support device is configured to resiliently support the guide member when pivoting about the first pivot axis, preferably progressively resiliently with increasing pivot angle in both pivot directions.

14. The floor cleaning device of claim 4, characterized in that the joint assembly comprises a connecting member connecting the first pivot joint to the second pivot joint, wherein the connecting member is pivotable relative to the floor unit about the second pivot axis and the guide member is pivotable relative to the connecting member about the first pivot range with its first pivot axis.

15. The floor cleaning device of claim 14, characterized in that the connecting member can be supported, resiliently, where applicable, with respect to the floor unit.

16. The floor cleaning device of claim 5, characterized in that the support device is assigned to the connecting member and comprises a support member which in the maneuvering operating state, contacts the floor unit, thereby providing support.

17. The floor cleaning device of claim 5, characterized in that the support device is integrally formed with the joint assembly or as a separate assembly that is preferably modularly attachable to and detachable from the floor cleaning device.

18. The floor cleaning device of claim 5, characterized in that the joint assembly is configured as a double universal joint and the support device or at least one of the support devices is integrally formed with the double universal joint.

19. The floor cleaning device of claim 5, characterized in that the support device can be activated or deactivated by an operator as required.

20. The floor cleaning device of claim 19, characterized in that the support device is pivotable by an operator between an operating position and a parking position, wherein the support device is preferably lockable in at least one of the operating position and the parking position.

21. The floor cleaning device of claim 5, characterized in that an adhesion member, in particular a magnet, is assigned to the support device and is configured to secure the support device during support against pivoting contrary to the support direction up to a limit force.

22. The floor cleaning device of claim 21, characterized in that the support device provides, preferably via the adhesion member, a substantially positive or/and non-positive connection between the support device and the guide member and/or the floor unit.

23. The floor cleaning device of claim 4, characterized in that the second pivot axis is substantially perpendicular relative to the first pivot axis.

24. The floor cleaning device of claim 1, characterized in that the guide member comprises a longitudinal axis which is preferably perpendicular to the first pivot axis and, where applicable, perpendicular to the second pivot axis.

25. The floor cleaning device of claim 1, characterized in that the joint assembly is attachable to the floor unit in such a way that the weight force of the guide member is introduced via the joint assembly into the floor unit at a geometric location of the floor unit which, as seen in the direction of advance, is located in front of a center of area or center of mass of the floor unit.

26. The floor cleaning device of claim 1, characterized in that the floor unit comprises a fastening device by means of which the joint assembly can be variably fastened to the floor unit at different fastening positions along the direction of advance.

27. The floor cleaning device of claim 1, characterized in that a mass ratio between floor unit and guide member ranges between 1:5 and 1:1 or between 1:1 and 5:1.

28. The floor cleaning device of claim 1, characterized in that the floor cleaning device further includes a parking state, wherein in the parking state the floor unit is displaceable relative to the guide member into a space-saving parking position and lockable in such position.

29. The floor cleaning device of claim 1, characterized in that the support device is configured to fully lock the guide member with respect to the floor unit, so that pivoting about the first pivot axis and, where applicable, about the second pivot axis is blocked at least in a predetermined angular range.

30. A support device for a floor cleaning device of claim 1.

31. The support device of claim 30, comprising a base by means of which it is attachable either to a shaft or to the floor unit, and at least one support strut which introduces the weight force of the shaft into the floor unit permanently or by displacement into a support position.

32. The support device of claim 30, wherein the support device comprises a locking bracket which is preferably pivotable, wherein the locking bracket is configured to block any pivoting of the guide member about the first pivot axis or to block pivoting only from a predetermined pivot angle.
